(19) United States
(12) Patent Application Publication
(10) Pub. No.: US 2007/0256011 A1
(43) Pub. Date: Nov. 1, 2007

(54) Method and system of generating customized story books

(76) Inventor: David Jones, Studio City, CA (US)

Correspondence Address: EDWIN TARVER, 16830 Ventura Blvd., SUITE 360, Encino, CA, 91436, US

(21) Appl. No.: 11/412,323

(22) Filed: Apr. 26, 2006

(51) Int. Cl. G06F 17/00

(52) U.S. Cl. 715/523

(57) ABSTRACT

A method of customizing and producing story books. The method provides a database, which includes a plurality of stories with variable text and illustrations, non-variable text and illustrations, and modifiable three-dimensional wire frame models and two-dimensional representations of the wire frame models of the variable illustrations such as characters and objects. The database is made accessible to a user through a computer system connected to the Internet, or through a system physically located in a publicly accessible location. A user interface is provided to customize the variable text and illustrations. The variable text and illustrations are loaded into the story book after customization. Relevant segments of the variable text are automatically changed based on the customization of the illustrations. The customized story book is then converted to a print-friendly format, which can be transmitted to a printer or to a printing facility.

### CROSS-REFERENCE TO RELATED APPPLICATION

None

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to a method of customizing publications, and more particularly to a method of creating a customized story book for children.

Printed materials such as calendars, cards and story books are easily customized using Internet or home computer based editing programs. Generally, a database including all the necessary data for customization is made accessible, and after launching a program or logging on to a hosting website, a user is guided through a graphic interface that includes a variety of customization features.

Several methods and systems for customizing media have been developed in art. For example, U.S. Pat. No. 6,694,482 to Arellano discloses a system and method for creating and delivering interactive multimedia content that can dynamically adapt to at least one user. The system creates a multimedia story based on interests and trends of the at least one user model. A customized presentation of the multimedia story is generated, which is modified based on the input from at least one user.

U.S. Pub. No. 2002/0124048 to Zhou discloses a web based interactive multimedia story authoring system and method. The system includes a user part, a computer server part and a communications part. A user is able to create stories while being logged on to the website, through selection of various story components like text, background, character, music or other files as arranged and selected by the user. The system also allows for publication of stories to worldwide audience.

U.S. Pub. No. 2002/0077848 to Campbell discloses a method of creating a customized product. The method includes presenting a customizable template to a customer who provides the names of people, pets and places the reader or customer is familiar with for incorporation into a book. Once a user selects the names, images and other customizable story variations, the book is published and sent to the user. The customized products may include a book, game, toy and other products.

Although the above methods are related to creating customized stories for books or other similar products, they lack the ability to define variable and non-variable text and illustration elements, and have no means of customizing characters and illustrations. Moreover, none of the above methods contemplate customization of characters and objects in stories by manipulation of three-dimensional wire frame models.

Therefore, it is an object of the present invention to provide a system and method of creating a customized story book by using both non-variable text and illustrations, and variable text and illustrations that are customizable.

A further object is to provide a system and method of creating a customized story book by using three-dimensional wire frame models of the characters and other entities in the story.

A further object is to provide a system and method of creating a customized story book, which includes a convenient means to customize the variable text and illustrations.

A further object is to provide a system and method of creating a customized story book, which automatically changes some segments of the variable text based on the customized illustrations.

Finally, it is an object of the present invention to provide a system and method of creating a customized story book, which converts the customized story book to a printer friendly format and transmits or delivers it to a printing facility. These and other objects of the present invention will become better understood with reference to the appended Summary, Description, and Claims.

### SUMMARY

The present invention relates in general to a method of customizing products, and more particularly to a method and system of creating a customized story book. A database with all the necessary information required for customization is provided. The database includes a plurality of stories with non-variable text and illustrations and variable text and illustrations. A user can access the database through the Internet.

In order to employ the method of the present invention, a user opens a hosting webpage and logs into the database. Initially, users are required to select a story. The user is then guided through a plurality of web pages for customizing the selected story. The structure of each story remains static, however all stories include customizable text such as the physical characteristics of a character, descriptive passages concerning various characters, and the like. Illustrations in each story, such as the appearance of characters and objects, the background, and the surroundings are also customizable. The plurality of web pages includes a means to customize both text and illustrations, for example, text can be typed into a field on the web page, and the color or texture of an illustration can be selected from the options provided on the web page.

To make the customization of illustrations more versatile, three-dimensional wire frame models and/or previously rendered two dimensional representations of the wire frame models of characters and objects are provided in the database. The user can customize the physical appearances of the characters and the objects by altering the wire frame models directly using various tools provided by the customization interface, or by navigating through a library of pre-rendered 2D images. A means comprising a plurality of selectable options or mouse operations provided on the web pages are used to customize both characters and objects.

After customization, a proprietary software application instructs 3D rendering software to load all variable and non-variable customizations, including customized wire frame models into memory or a proprietary application instructs 2D compositing software to load all customizations as pre-rendered 2D elements/images (in an image formats such as .jpg, etc.) into memory. All customized pages of the story book are then rendered as images files or 2D elements are composited to make the complete page and are saved as a single image file. The output files are compiled via secondary proprietary software applications in a printer friendly format. A single file comprising the entire story is then delivered or transmitted online to a print-on-demand facility, or user.

### BRIEF DESCRIPTION OF THE FIGURES

FIG. 1 represents a flow chart of the present invention.

FIGS. 2A through 2C are examples of interface screens used to customize facial features of a character.

FIGS. 3A through 3C are examples of interface screens used to customize costumes of a character.

FIGS. 4A through 4D are illustrative examples of the steps involved in production phase of the present invention.

FIGS. 5A through 5C are examples of simplified versions of a final page.

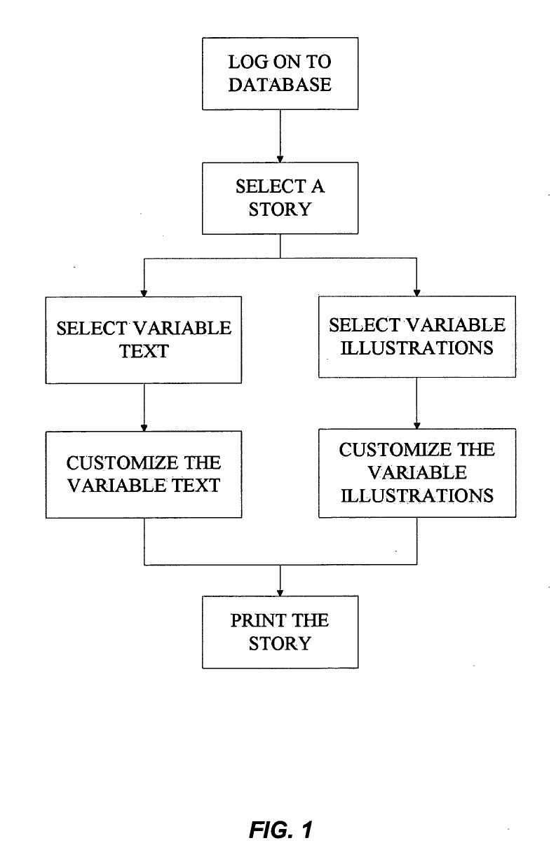

### FIGURES—REFERENCE NUMERALS

None

### DETAILED DESCRIPTION

Although the present invention includes a method and system for customizing and producing a variety of products such as greeting cards, comic books, holographs, clothing and other products, the preferred embodiment of the present invention is described in terms of customizing and producing a story book for children.

The system of the present invention is mainly divided into a customization phase, a production phase and a fulfillment phase. A database containing all software applications necessary for customizing a story book is provided. The database also includes a plurality of stories with both non-variable and variable text and illustrations, which are created independently, and setup in the database during a preproduction phase. The database is available for access by users through a hosting website, which is accessible through the Internet.

Using a computer connected to the Internet, users open the hosting website and log into the database via a welcome screen (not illustrated). In the product customization phase, users are provided with options to customize or modify text and illustrations of a story designated as variable. Non-variable text and illustrations are also presented, and although not customizable, represent the basic outline or main theme of a story.

Once a user is logged in, a second web page is provided that allows the user to select from a library of stories available for customization. After browsing through the plurality of stories, the user selects one and is guided through a tutorial explaining the basic concept of customization, and how it applies to variable text and variable illustration elements. The variable text may include the name, age, and descriptive information for a character, which can be customized by the user. The variable illustrations may include colors, shapes and features associated with a character or object, including the character or object's background and surroundings.

To make the customization more versatile, three-dimensional wire frame models of characters and objects are included in the database. These wire frame models are created by using 3D rendering software that gives them three dimensional characteristics that can be modified in three dimensions. Using a humanoid figure as an example; a typical customization might consists of the following: A three-dimensional wire frame model of the figure is presented to the user, and used to customize physical appearance. For example, the overall shape of the head; the size, shape, and placement of the various features of the face such as eyes, nose, mouth, and the like; the coloring and complexion of hair, eyes, and skin; and a variety of clothing that might be worn according to the story.

In addition to three-dimensional wire frame models, pre-rendered two-dimensional images of the wire frame models of characters and objects are also included in the database. These pre-rendered images are created by using 3D rendering software that gives them the appearance of having three dimensional characteristics. Using a humanoid figure as an example; a typical customization might consists of the following: A pre-rendered two-dimensional model of the figure is presented to the user, and by cycling through various images contained in the pre-rendered image library, the figure can be customized to the user's specifications. For example, the overall shape of the head; the size, shape, and placement of the various features of the face such as eyes, nose, mouth, and the like; the coloring and complexion of hair, eyes, and skin; and a variety of clothing that might be worn according to the story.

Two-dimensional texture maps included in the database can also be applied to the models of characters and other objects. These texture maps are created by using 2D paint software or scanning imagery, such as photographs, illustrations, and the like, and then applied to the wire frame model. Most of the changes to a character's visual identity are made by application/replacement of these texture maps on top of the 3D geometry. A variety of texture maps can be used on a single wire frame mesh to create more potential variations, without a physical change to the geometry.

As users are guided through the plurality of web pages (not illustrated) for customizing the figure, options are provided on the plurality of web pages to provide a means for customization of the physical appearance of the figure along with associated text customization such as name, age, and related descriptive text. In a preferred embodiment, a user is first asked to enter a name for the figure, which can be entered on a particular field of the web page. Similarly, descriptive text can be entered on the consecutive web pages, completing the customization of variable text in this manner. Following this process, other web pages (not illustrated) related to customizing physical appearance are provided, which include input means such as data fields or mouse operations. In these pages, users can input or select features such as skin color, hair color or texture, eye shape and color, and any other variable features related to the story. In addition, a computer mouse or other graphic user interface device can be used to change physical features by allowing manual manipulation of features.

Other prominent non-character objects in the selected story are also customizable. These would include objects that can be held by characters, or come into contact with characters in other ways. In addition to objects, the scene comprising the background for a story may also be customizable, including variable geographical elements.

In this manner, a wide variety of characters and objects may be customized according to the particular story selected for customization. Certain segments of variable text are automatically changed based on the customization of the variable illustrations. For example, the descriptive passages of a figure can be automatically generated based on gender, age, and physical appearance characteristics of a selected character type. As this information is modified by a user, the character description is updated in the story.

Generally, during production phase, a proprietary software application instructs 3D rendering software or 2D compositing software to load the customized objects and/or images into memory. In either case, the variable illustrations such as figures and objects are represented first by placeholders, and are automatically modified using a custom software application to conform the figures and objects to the specifications made by a user. All necessary pages of the story book are rendered as complete image files, compiled into a printer friendly format and delivered or transmitted online to a print-on-demand facility in the fulfillment phase.

The present invention can be executed using two more-detailed and preferred methods: pre-rendered 2D method and real time 3D method. In both the methods, first a user downloads and launches a software application required for customization. The end user can download the software via internet or through a mass storage medium such as CD, DVD or flash card. The software is then installed in the user's personal computer. The user can also access a computer system, with the necessary software applications, located in a children's section of a book store.

During the customization phase of the pre-rendered method, only the pre-rendered two-dimensional images of the wire frame models are made available to the user. The two-dimensional images are created by artists using 3D modeling and rendering applications. The number of available customizing options for each variable illustration is dependent on the number of variations created by the artists during development of the story. The user can customize by dragging and dropping various elements in the customization screen with a mouse.

The elements that comprise the customizable aspects of the story exist on a server or other suitable storage medium such as a library of pre-rendered two dimensional images. During the production phase of the pre-rendered method, the customized images of each page are loaded via proprietary software applications into a 2D compositing program or similar application which layers a series of images by combining both variable and non-variable illustrations together to from the pre-defined layout of the book.

During the customization phase of the real time method, three-dimensional wire frame models, texture maps, and other surface attributes that define overall look of a character or an object are loaded into memory. The 3D mesh is rendered in real time and the user can manipulate the variable elements via a series of onscreen controls. The 3D wire frame mesh and associated texture maps may be of final quality as the printed output, or of lowered quality to speed up the display process and later converted to higher quality.

During the production phase of the real time method, the modifications for the wire frame models are recorded and the data is made accessible to a 3D rendering application via a proprietary software application, which instructs the 3D rendering application to load all the correct scene file for each page of the book. A single file can also contain all the data necessary to render an entire book. The scene file contains both variable and non-variable elements. The variable elements have stand-in models that the application or custom loader will replace with the user modified content. Once loaded into memory, the 3D wire frame models and associated textures are either refined into a higher resolution or replaced by high resolution wire frames from a content directory of wire frame meshes and the textures maps. The wire frame mesh itself may be manipulated to reflect the modifications. All the pages of the book are then rendered into high resolution image files.

In the fulfillment phases of the pre-rendered and the real time methods, all necessary pages of the story book are rendered as complete image files and compiled using proprietary software applications into a printer friendly format, which is then delivered or transmitted online to a print-on-demand facility for printing. The user can also select the paper stock and binding options for the story book, depending on which the print-on-demand facility fulfills the order.

Referring to FIGS. 2 through 5, illustrative examples are used to explain some of the steps involved in the execution of the present invention. FIG. 2A shows an example of one possible type of interface screen for customizing a character. Basic controls for modifying the associated parts of the wire frame model, namely, eyes, lips, and nose, are on the left side of the screen. The present illustration indicates a real-time 3D wire frame mesh of the character. FIG. 2B shows the slightly modified character of FIG. 2A. FIG. 2C compares FIGS. 2A and 2B. Constraints can be imposed to limit the extent of modification in order to preserve the nature of a character.

Referring to FIGS. 3A through 3C, an example of drag and drop type interfaces are illustrated. This interface is almost similar for pre-rendered 2D method and the real time 3D method, except that the real time method would display a lower quality image during customization, which would allow the user to rotate it around and view it from different angles. In this example, only three hairstyles, three skirts/pants, and two tops are available for selection. FIG. 3B shows the character after the user added a hairstyle using drag and drop option. FIG. 3C shows the character after the user dragged and dropped pants, a sweatshirt, a necklace and arm warmers.

FIGS. 4A through 4D illustrate a simplified version of processes involved during the production phase with examples. FIG. 4A shows a scene loaded into memory with a skeleton of a character, a camera and a light. The skeleton will dictate the character's pose in this particular scene. FIG. 4B shows an example of how a low resolution version of the wire frame date exported from the customization application and associated textures (not shown) are loaded into memory and conformed to the skeleton of FIG. 4A. FIG. 4C shows the low resolution model that is modified by the user and FIG. 4D shows the subdivision process of refining low resolution wire frame mesh into a higher resolution mesh.

FIGS. 5A through 5C are examples of simplified versions of a final page with variable elements in place. They also show an example of how variable text is applied.

A variety of software applications can be employed for the present invention. The database can also be made available for access by users through a computer system installed in a kiosk, book store, children's store, or any suitable location. In such a case, the customization and the production phases can be combined into a real time application run directly from the kiosk or book store to deliver the story book almost immediately. In addition to creating three-dimensional wire frame models of the characters, three-dimensional laser scanning devices can be employed to capture the data and generate a wire frame model of an individual, thereby allowing him/her to be a part of their customized story book. Also, three-dimensional objects of individuals and caricatures can be sculpted and further scanned for use in the story book.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. §112, paragraph 6. In particular, the use of “step of” in the claims herein is not intended to invoke the provisions of 35 U.S.C. §112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A method of customizing and producing story books, the method comprising the steps of;
providing a database comprising a plurality of stories, wherein each of the plurality of stories includes variable text and illustrations, non-variable text and illustrations, and modifiable three-dimensional objects, namely wire frame based models of, characters and objects relevant to an individual story;
making the database accessible to a user for customizing the variable text and illustrations;
providing a user interface and a means in the user interface for the user to customize the variable text and illustrations;
loading the customized text and illustrations in the selected story, relevant segments of the variable text being automatically loaded/updated based on the customization of the illustrations;
converting the customized story to a printer friendly format;
transmitting or delivering the printer friendly customized story to a printer or printing facility for printing the story.

2. The method of claim 1, wherein the database is available for access by the users through a hosting website.

3. The method of claim 1, wherein the database is available for access by the users through a computer system installed in a kiosk, book store, children's store, or other public location through a publicly usable computer interface.

4. The method of claim 1, wherein the user interface comprises a plurality of screens, which include user executable commands such as options or mouse operations to customize the non-variable text and illustrations.

5. The method of claim 4, wherein the variable illustrations include options to change the content of text and the visual appearance of illustrations comprising color, texture, and shape.

6. The method of claim 4, wherein the variable text include options to customize the name, age, and description of a character in the story.

7. The method of claim 4, wherein options to customize the physical attributes including facial features, hairstyle, color of skin, eyes, and hair, among others of the three-dimensional wire frame models of the variable illustrations are provided.

8. The method of claim 4, wherein options to customize the costumes of characters comprising the three-dimensional wire frame models of the variable illustrations are provided.

9. The method of claim 4, wherein options are provided to customize the color, shape, and attributes of the three-dimensional wire frame model variable illustrations and variable text.

10. The method of claim 1, wherein the three-dimensional wire frame models are created using rendering software that renders images in real-time as the wire frame models and variable text are altered by a user, or when customization is complete.

11. The method of claim 1, wherein a scanning device is used to scan a child or an individual for generating the three-dimensional wire frame models, which are used in place of the variable illustrations of the characters.

12. The method of claim 1, wherein the method is also adapted to customize greeting cards, comic books, coloring books, 3D books, holographs, clothing, and accessories such as wallets and purses, and other similar products.

13. The method of claim 1, wherein the database comprises two-dimensional texture maps, which can be applied to the wire frame models of characters and other objects.

14. The method of claim 13, wherein the texture maps are created by using 2D software and/or scanned images.

15. The method of claim 13, wherein a variety of texture maps can be used on a single wire frame model to create potential variations, without physically changing the geometry of the wire frame model.

16. A method of customizing and producing story books, the method comprising the steps of;
providing a database comprising a plurality of stories, wherein each of the plurality of stories includes variable text and illustrations, non-variable text and illustrations, modifiable pre-rendered two-dimensional representations of wire frame models of the variable illustrations, namely, characters and objects that are relevant to the plurality of stories;
making the database accessible to a user for customizing the variable text and illustrations;
providing a user interface and a means in the user interface for the user to customize the variable text and illustrations;
loading the customized text and illustrations in the selected story, relevant segments of the variable text being automatically loaded/updated based on the customization of the illustrations;
converting the customized story to a printer friendly format;
transmitting or delivering the printer friendly customized story to a printer or printing facility for printing the story.

17. The method of claim 16, wherein the variable illustrations with the two-dimensional representations of the wire frame models of the characters include options to customize the physical attributes such as facial features, hairstyle, color of skin, eyes, and hair, and the like.

18. The method of claim 16, wherein the variable illustrations with the two-dimensional representations of the wire frame models of the characters include options to customize the costumes of the character.

19. The method of claim 16, wherein the variable illustrations with the two-dimensional representations of the wire frame models of the objects include options to customize the color, shape, decals, prints or lettering, and the like.

20. The method of claim 1, wherein the two-dimensional representations of the wire frame models are created using a 3D rendering software, which provides the flexibility to create complex and high quality imagery.
